(19) United States
(12) Patent Application Publication
(10) Pub. No.: US 2008/0035097 A1
(43) Pub. Date: Feb. 14, 2008

(54) Air-cleaner support structure

(76) Inventors: Yoichi Onishi, Okazaki-shi (JP); Toshio Hayashi, Obu-shi (JP); Takuji Atomura, Toyota-shi (JP)

Correspondence Address: KENYON & KENYON LLP, 1500 K STREET N.W., SUITE 700, WASHINGTON, DC, 20005, US

(21) Appl. No.: 11/806,925

(22) Filed: Jun. 5, 2007

(30) Foreign Application Priority Data
Jun. 5, 2006 (JP) 2006-156070

(51) Int. Cl. F16M 1/00

(52) U.S. Cl. 123/195 A

(57) ABSTRACT

An air-cleaner support structure includes an air-cleaner, a first support portion and a second support portion. The air-cleaner is supported in an engine room via the first support portion and the second support portion. The first support portion is connected to the air cleaner using a bolt and the second support portion is connected to the air-cleaner using an insert member. The distance from the engine to the first support portion is shorter than the distance from the engine to the second support portion.

### INCORPORATION BY REFERENCE

The disclosure of Japanese Patent Application No. 2006-156070 filed on Jun. 5, 2006 including the specification, drawings and abstract is incorporated herein by reference in its entirety.

### BACKGROUND OF THE INVENTION

1. Field of the Invention

The invention relates to an air-cleaner support structure for an air cleaner that is provided in an intake system of an internal combustion engine for a motor vehicle or the like and is supported in the engine room.

2. Description of the Related Art

Generally, in an internal combustion engine for a motor vehicle or the like, the air cleaner of the intake system is mounted in the engine room (vehicle body) by being bolted to several points, and cushioning members, such as cushioning rubbers, are interposed between the air cleaner and the respective bolted points. Being elastic, the cushioning rubbers reduce vibration transmitted from the engine. One example of such an air-cleaner support structure is described in Japanese Utility Model Application Publication No. 01-95568. In the air-cleaner support structure in this publication, an air-cleaner is fixed in position by being bolted to three points and cushioning rubbers are interposed between the air cleaner and the three bolted points, respectively.

Meanwhile, in some cases, the restriction of the space in the engine room makes it impossible to use a sufficiently long air-cleaner tube. Because a short air-cleaner tube has a low allowable twist level and thus is relatively difficult to be twisted, the following problem may occur.

When some vibration, such as roll vibration of the engine, is transmitted to the intake system of the engine, the air-cleaner tube and the air cleaner move with the movements of the engine. At this time, the cushioning rubbers interposed between the air cleaner and the respective bolted points extend or contract to allow the air cleaner to move with the movement of the engine. However, the movable range of the air cleaner that is obtained by the extension and contraction of the cushioning rubbers is narrow. Thus, the movement of the air cleaner may fail to follow a large movement of the engine, which creates a positional deviation between the engine and the air cleaner and causes the air-cleaner tube to be twisted to an extent exceeding its allowable level. As a result, the air-cleaner tube deteriorates and its life decreases accordingly.

### SUMMARY OF THE INVENTION

The invention provides an air-cleaner support structure that extends the life of an air-cleaner tube connected to an engine by minimizing deterioration of the air-cleaner tube.

An aspect of the invention relates to an air-cleaner support structure including an air cleaner provided in an intake system of an internal combustion engine, a first support portion and a second support portion. The air-cleaner is supported in an engine room via the first support portion and the second support portion. The first support portion is connected to the air-cleaner using a bolt, the second support portion is connected to the air-cleaner using an insert member, and the distance from the internal combustion engine to the first support portion is shorter than the distance from the internal combustion engine to the second support portion.

In the air-cleaner support structure according to the above aspect of the invention, when the internal combustion engine vibrates, the distance from a center of vibration of the internal combustion engine to the first support portion may be shorter than the distance from the center of vibration of the internal combustion engine to the second support portion.

In the air-cleaner support structure according to the above aspect of the invention, the second support portion may be connected to the air-cleaner such that the second support portion moves in an arc about the center of vibration of the internal combustion engine.

In the air-cleaner support structure according to the above aspect of the invention, the center of vibration of the internal combustion engine may be a center of roll vibration of the internal combustion engine.

According to this structure, when vibration, such as roll vibration of the internal combustion engine, is being transmitted to the intake system, the air cleaner moves in an arc about the vibration center of the internal combustion engine by an angle substantially equal to the angle by which the internal combustion engine tilts. This suppresses the positional deviation between the engine and the air cleaner and thus reduces the degree of twisting of the air-cleaner tube via which the air cleaner is connected to the engine. As such, this support structure minimizes deterioration of the air-cleaner tube and thereby extends the life of the air-cleaner tube.

The insert member may be an elastic member, such as a rubber grommet.

As such, according to the air-cleaner support structure according to the above aspect of the invention, the positional deviation between the internal combustion engine and the air cleaner is suppressed, and the degree of twisting of the air-cleaner tube decreases accordingly. As a result, deterioration of the air-cleaner tube is minimized, so that the life of the air-cleaner tube extends accordingly.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a plan view schematically showing the intake system of an internal combustion engine incorporating an air-cleaner support structure according to the invention;

FIG. 2 is a side view schematically showing the air-cleaner support structure shown in FIG. 1;

FIG. 3 is a cross-sectional view taken along the line III-III in FIG. 1;

FIG. 4 is a cross-sectional view taken along the line IV-IV in FIG. 1;

FIG. 5 is a side view schematically showing a modification example of the air-cleaner support structure shown in FIG. 1;

FIG. 6 is a side view schematically showing another modification example of the air-cleaner support structure shown in FIG. 1; and

FIG. 7 is a side view schematically showing still another modification example of the air-cleaner support structure shown in FIG. 1.

### DETAILED DESCRIPTION OF THE EXEMPLARY EMBODIMENTS

Hereinafter, an exemplary embodiment of the invention will be described with reference to the accompanying drawings.

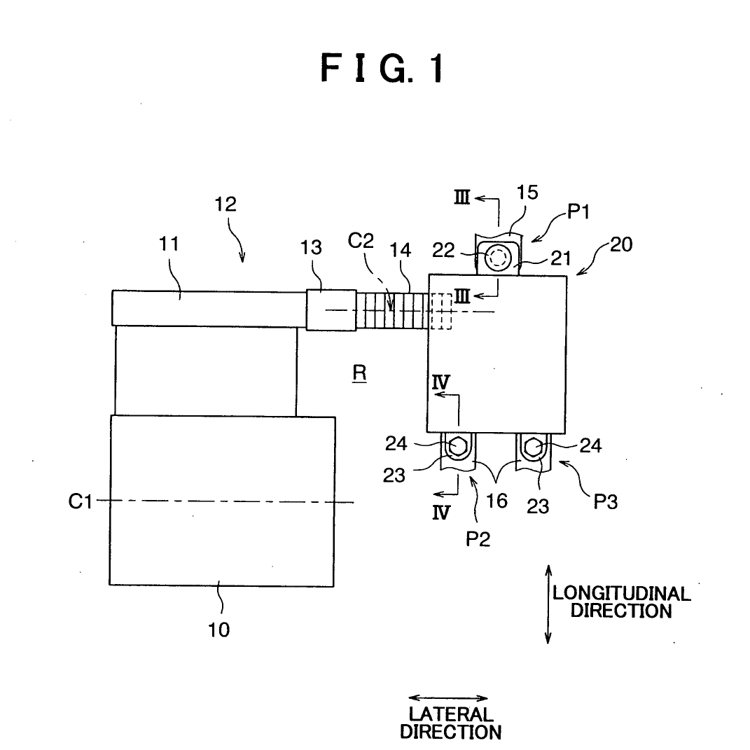

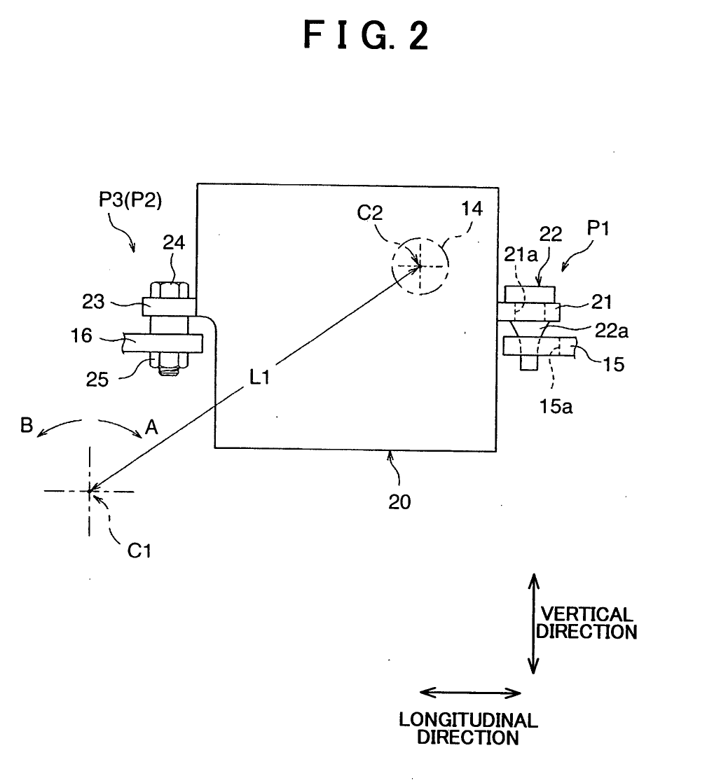

FIG. 1 is a plan view schematically showing the configuration of the intake system of an internal combustion engine incorporating an air-cleaner support structure according to the invention. FIG. 2 is a side view schematically showing the air-cleaner support structure.

An internal combustion engine 10 (will be simply referred to as “engine 10”) is, for example, an inline four-cylinder engine. The engine 10 has an intake manifold 11. An intake system 12 for introducing air into the engine 10 is connected to the intake manifold 1. The intake system 12 has an air cleaner 20 and a throttle body 13 that are arranged in this order from the upstream side of the intake flow. The spaces in these components together form an intake passage through which air is drawn into each cylinder of the engine 10.

The air cleaner 20 contains an air-cleaner element. The upstream portion of the air cleaner 20 (the first side space of the air-cleaner element) is connected to an air inlet, which is not shown in the drawings. The air inlet forms a passage from which air is introduced into the air cleaner 20. The downstream portion of the air cleaner 20 (the second side space of the air cleaner element) is connected to the throttle body 13 via an air-cleaner tube 14. In the intake system 12 of the engine 10 configured as described above, the air introduced from the air inlet (intake air) is purified by the air-cleaner element as it passes through the air cleaner 20, and the air then proceeds to the throttle body 13 via the air-cleaner tube 14. The air-cleaner tube 14 is a pleated flexible tube and generally straight. In FIG. 1 and FIG. 2, C1 indicates the center of roll vibration (vibration center) of the engine 10 and C2 indicates the center of the air-cleaner tube 14.

In an engine room R, the air cleaner 20 is supported on the inner side of the engine room R (vehicle body) via three support portions P1, P2, and P3 that are provided at different positions in the engine room R. Hereinafter, the support structure for the air cleaner 20 will be described in detail.

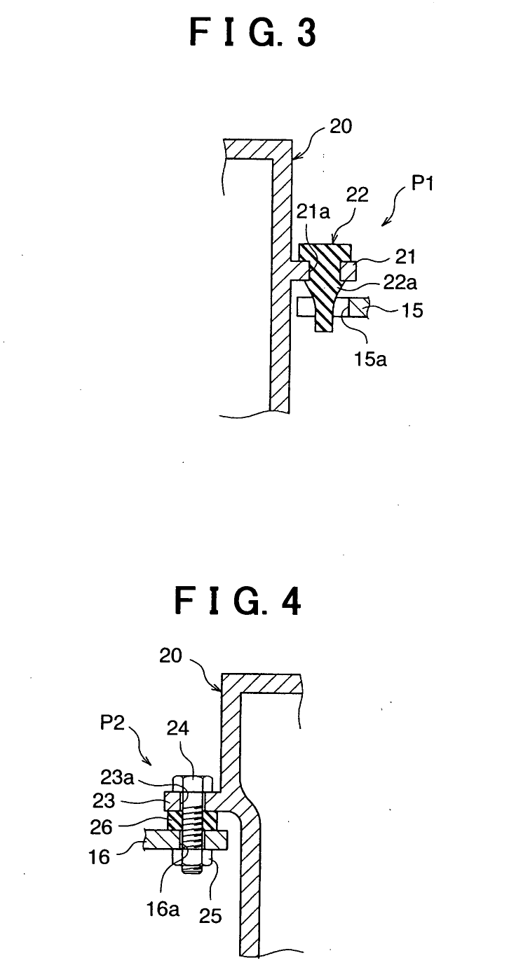

In the engine room R, the air cleaner 20 is supported on the inner side of the engine room R through a grommet connection as shown in FIG. 3 and bolt connections as shown in FIG. 4. More specifically, in this exemplary embodiment, the air cleaner 20 is grommeted at the support portion P1 and bolted at the support portions P2, P3. The distances from the vibration center C1 of the engine 10 to the bolted support portion P2 and to the bolted support portion P3 are shorter than the distance from the vibration center C1 to the grommeted support portion P1. In this exemplary embodiment, referring to FIG. 2, the positions of the support portions P1, P2, P3 are determined by using a distance L1 between the vibration center C1 of the engine 10 and the center C2 of the air-cleaner tube 14 as the positional reference. That is, the support portions P1 is arranged at a position, the distance from which to the vibration center C1 of the engine 10 is longer than the reference distance L1, and the support portions P2, P3 are arranged at positions, the distances from which to the vibration center C1 of the engine 10 are shorter than the reference distance L1.

With regard to the grommet connection at the support portion P1, a rubber grommet 22 is used as an insert member. The upper portion of the grommet 22 is fit in a through hole 21a of an air-cleaner bracket 21 that is integrally formed on the air cleaner 20 while the lower portion of the grommet 22 is inserted into a U-shaped notch 15a of a mounting bracket 15 that is integrally provided on the inner side of the engine room R. The portion of the grommet 22 located below the air-cleaner bracket 21 is tapered downward, thus forming a tapered portion 22a. The upper surface of the tapered portion 22a gets stuck with the periphery of the through hole 21a of the air-cleaner bracket 21, whereby the grommet 22 is prevented from coming out from the through hole 21a.

The grommet 22 is inserted into the mounting bracket 15 such that the grommet 22 is movable in the direction along an arc about the vibration center C1 of the engine 10 (i.e., movable substantially in the vertical direction in FIG. 2). More specifically, the grommet 22 can move upward and downward almost freely relative to the mounting bracket 15 (See FIG. 2). There is a gap between the tapered portion 22a of the grommet 22 and the mounting bracket 15 in the longitudinal direction (See FIG. 1 and FIG. 2). Thus, the grommet 22 can move in the longitudinal direction by a distance corresponding to the width of the gap. The side faces of the tapered portion 22a in the lateral direction (See FIG. 1) are in contact with the mounting bracket 15, whereby the grommet 22 is retained in position in the lateral direction.

With regard to the bolt connection at the support portion P2, a bolt 24 is inserted, from above, into a through hole 23a of an air-cleaner bracket 23 that is integrally formed on the air cleaner 20 and into a through hole 16a of a mounting bracket 16 that is integrally formed on the inner side of the engine room R, and a nut 25 is fastened to the bolt 24. A cushion rubber 26, which is a cushioning member, is interposed between the air-cleaner bracket 23 and the mounting bracket 16. The cushion rubber 26 is arranged between the air-cleaner bracket 23 and the mounting bracket 16 such that it can extend and contract in the vertical direction. Note that the bolt connection at the support portion P3 is the same as above.

The above-described support structure for the air cleaner 20 provides the following advantages, as well as small vibrations to the air cleaner 20 being absorbed due to the elasticity of the grommet 22 and the cushion rubber 26.

That is, the air cleaner 20 is bolted at the support portions P2, P3 that are closer to the vibration center C1 of the engine 10 than the center C2 of the air-cleaner tube 14 is, and the air cleaner 20 is grommeted at the support portion P1 that is farther from the vibration center C1 of the engine 10 than the center C2 of the air-cleaner tube 14 is. This structure allows the air-cleaner tube 14 and the air cleaner 20, when vibration, such as roll vibration of the engine 10, is being transmitted to the intake system 12, to move in the same manner as the engine 10 does, so that the movements of the air-cleaner tube 14 and the air cleaner 20 follow the movement of the engine 10. More specifically, the air-cleaner tube 14 and the air cleaner 20 can move in an arc about the vibration center C1 of the engine 10 by almost equal angles. That is, when the air cleaner 20 is moving about the vibration center C1 of the engine 10, the cushion rubbers 26 at the support portions P2, P3 extend or contract while the grommet 22 at the support portion P1 moves relative to the mounting bracket 15 in the direction along an arc about the vibration center C1 (substantially vertical direction in the structure of this exemplary embodiment). As such, the air cleaner 20 can move in an arc by an angle substantially equal to the angle by which the air-cleaner tube 14 can move in an arc.

More specifically, when the engine 10 is tilting in the direction A in FIG. 2 about the vibration center C1 during roll vibration or the like, the cushion rubbers 26 at the support portions P2, P3 are compressed while the grommet 22 at the support portion P1 moves almost straight downward relative to the mounting bracket 15, so that the air cleaner 20 moves in the direction A in an arc about the vibration center C1 of the engine 10. At this time, the tapered portion 22a of the grommet 22 that is in contact with the mounting bracket 15 to hold the grommet 22 in position is compressed. On the other hand, when the engine 10 is tilting in the direction B in FIG. 2, the cushion rubbers 26 at the support portions P2, P3 extend while the grommet 22 at the support portion P1 moves almost straight upward relative to the mounting bracket 15, so that the air cleaner 20 moves in the direction B in an arc about the vibration center C1 of the engine 10.

Thus, according to the air-cleaner support structure of this exemplary embodiment, when roll vibration, or the like, occurs, the air cleaner 20, as well as the air-cleaner tube 14, moves in the same manner as the engine 10 does, so that the movement of the air cleaner 20 follows the movement of the engine 10. This reduces the positional deviation between the engine 10 and the air cleaner 20 and thus reduces the degree of twisting of the air-cleaner tube 14. As such, the air-cleaner support structure of this exemplary embodiment minimizes deterioration of the air-cleaner tube 14 and thereby extends the life of the air-cleaner tube 14.

For example, the foregoing support structure for the air cleaner 20 can be effectively used in the case where the space for the air-cleaner tube 14 in the engine room R is not large enough to make the air-cleaner tube 14 sufficiently long. In this case, the air-cleaner tube 14 must be made short to be fit in the space and thus the allowable twist level of the air-cleaner tube 14 decreases. However, because the foregoing support structure for the air cleaner 20 reduces the degree of twisting of the air-cleaner tube 14, even if the air-cleaner tube 14 is twisted, the degree of the twisting does not exceed the allowable level.

Next, modification examples of the foregoing exemplary embodiment will be described.

In the exemplary embodiment described above, the reference distance L1 between the vibration center C1 of the engine 10 and the center C2 of the air-cleaner tube 14 is used as the positional reference, and the positions of the support portions P1, P2, and P3 are determined with respect to the reference distance L1 such that the distances from the vibration center C1 to the support portions P2, P3 are shorter than the distance from the vibration center C1 to the support portion P1. However, as long as the distance from the vibration center C1 to each bolted support portion can be made shorter than the distance from the vibration center C1 to the insert-connection support portion (i.e., grommet connection), the distance between the vibration center C1 of the engine 10 and the center C2 of the air-cleaner tube 14 is not necessarily used as the positional reference. For example, in a case where all the support portions are located closer to the vibration center C1 than the center C2 of the air-cleaner tube 14 is, the distance between the vibration center C1 and the center C2 is not used as the positional reference.

Further, the positions of the support portions P1, P2, and P3 are determined based on the vibration center C1 of the engine 10. However, the vibration center C1 of the engine 10 is not necessarily used as the base point. If the positions of the support portions P1, P2, and P3 are determined based on the engine 10, the movement of the air cleaner 20 follows the movement of the engine 10 similarly.

Further, while the air cleaner 20 is supported at three points, i.e., the support portions P1, P2, and P3 in the exemplary embodiment described above, the number of the supporting points of the air cleaner 20 is not limited to any number. For example, the air cleaner 20 may be supported via two support portions, that is, via one grommet-connection support portion and one bolt-connection support portion. Alternatively, the air cleaner 20 may be supported via four support portions, that is, via two grommet-connection support portions and two bolt-connection support portions.

Further, while the grommet 22 is inserted into the U-shaped notch 15a of the mounting bracket 15 in the exemplary embodiment described above, a through hole may be formed in the mounting bracket 15 and the grommet 22 may be inserted into the through hole. In this case, the through hole is preferably formed in a shape elongated in the longitudinal direction so that the air cleaner 20 can move smoothly in an arc in response to roll vibration of the engine 10, or the like.

Further, while the rubber grommet 22 is used as the insert member in the exemplary embodiment described above, a resin insert member may alternatively be used. In this case, the resin insert member is preferably made elastically deformable so that the air cleaner 20 can smoothly move in an arc in the direction A in FIG. 2 in response to roll vibration of the engine 10, or the like.

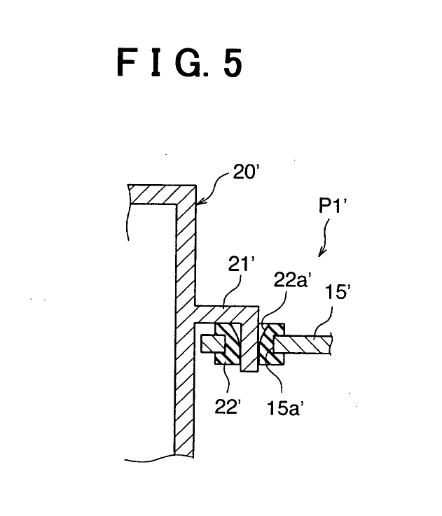

Further, while the insert member, which is the grommet 22, is provided separate from the air cleaner 20 in the exemplary embodiment described above, the insert member may be formed as a portion of the air cleaner 20 as in the example shown in FIG. 5. Referring to FIG. 5, at a support portion P1′, an insert portion 21′ that is formed as a portion of the air cleaner 20′ is inserted into a rubber grommet 22′ retained on an air-cleaner bracket 15′. In this case, the insert portion 21′ that is generally L-shaped is inserted into a through hole 22a′ of the grommet 22′ that is fit in a through hole 15a′ of the air-cleaner bracket 15′. The insert portion 21′ is inserted such that it can move relative to the grommet 22′ (air-cleaner bracket 15′) in the direction along an arc about the vibration center C1 of the engine 10.

Further, while the air-cleaner brackets 21, 23 are attached to the air cleaner 20 in the exemplary embodiment described above, such brackets may be omitted in some cases, such as when the air cleaner 20 is a separate type air cleaner that has a detachable air-cleaner cap on an air-cleaner case which contains an air-cleaner element and which is mounted directly on the inner side of the engine room R.

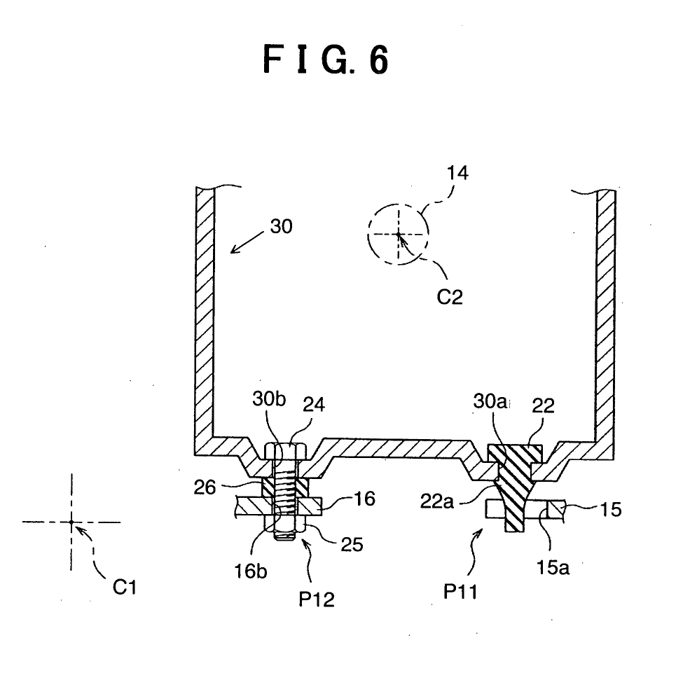

One example of such a structure is shown in FIG. 6. Referring to FIG. 6, a through hole 30a into which the grommet 22 is inserted and a through hole 30b into which the bolt 24 is inserted are formed at the bottom of the air-cleaner case 30, and therefore it is not necessary to provide any brackets for mounting the air cleaner case 30 on the inner side of the engine room R. More specifically, the air-cleaner case 30 is grommeted at a support portion P11 and bolted at a support portion P12. The structure of the grommet connection at the support portion P11 is the same as that of the grommet connection at the support portion P1 in the exemplary embodiment described above (See FIG. 3) except that the grommet 22 is inserted into the through hole 30a at the bottom of the air-cleaner case 30. Likewise, the structure of the bolt connection at the support portion P12 is the same as that of the bolt connection at the support portion P2 (and the support portion P3) in the exemplary embodiment described above (See FIG. 4) except that the bolt 24 is inserted into the through hole 30b at the bottom of the air-cleaner case 30.

Further, while the engine 10 and the air cleaner 20 are connected to each other through the air-cleaner tube 14 that is generally straight in the exemplary embodiment described above, a tube having a different shape may be used as the air-cleaner tube 14. For example, a bended tube may be used.

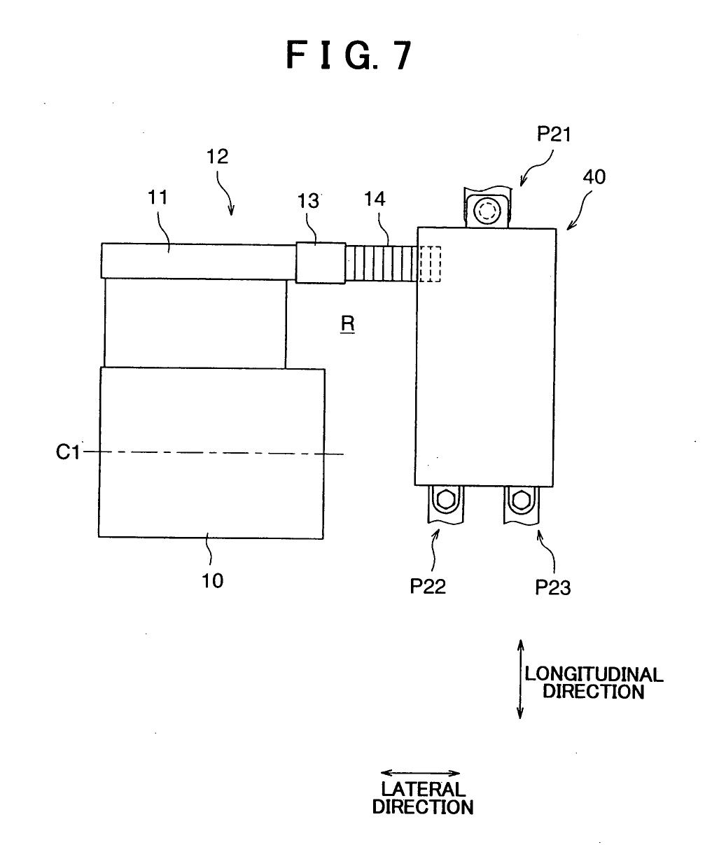

Further, while the support portions P1, P2, and P3 are arranged on the same side of the vibration center C1 of the engine 10 (i.e., the side where the air-cleaner tube 14 is located) as viewed in the plan view of FIG. 1 in the exemplary embodiment described above, the support portions P1, P2, and P3 may be arranged on both sides of the vibration center C1, respectively, as in the example shown in the plan view of FIG. 7. In the structure shown in FIG. 7, a grommet-connection support portion P21 is provided in the side of vibration center C1 of the engine 10 where the air-cleaner tube 14 is located while bolt-connection support portions P22, P23 are provided in the other side of the vibration center C1 so that the vibration center C1 is located between the support portion P21 and the support portions P22, P23, and an air cleaner 40 is supported via those support portions P21, P22, and P23.

What is claimed is:

1. An air-cleaner support structure comprising:
an air cleaner that is provided in an intake system of an internal combustion engine; and
a first support portion and a second support portion via which the air-cleaner is supported in an engine room, wherein
the first support portion is connected to the air-cleaner using a bolt,
the second support portion is connected to the air-cleaner using an insert member, and
the distance from the internal combustion engine to the first support portion is shorter than the distance from the internal combustion engine to the second support portion.

2. The air-cleaner support structure according to claim 1, wherein
the second support portion is connected to the air-cleaner such that the second support portion moves in an arc about the internal combustion engine.

3. The air-cleaner support structure according to claim 1, wherein
a U-shaped notch or an elongate hole is formed in the second support portion in which the insert member is inserted, so that the insert member moves in an arc about the internal combustion engine while the second support portion is connected to the air-cleaner.

4. The air-cleaner support structure according to claim 1, wherein,
when the internal combustion engine vibrates, the distance from a center of vibration of the internal combustion engine to the first support portion is shorter than the distance from the center of vibration of the internal combustion engine to the second support portion.

5. The air-cleaner support structure according to claim 4, wherein
the second support portion is connected to the air-cleaner such that the second support portion moves in an arc about the center of vibration of the internal combustion engine.

6. The air-cleaner support structure according to claim 4, wherein
the insert member is an elastic member.

7. The air-cleaner support structure according to claim 4, wherein
the insert member is an elastic grommet.

8. The air-cleaner support structure according to claim 4, wherein
a U-shaped notch or an elongate hole is formed in the second support portion in which the insert member is inserted, so that the insert member moves in an arc about the center of vibration of the internal combustion engine while the second support portion is connected to the air-cleaner.

9. The air-cleaner support structure according to claim 4, wherein
the second support portion and the insert member are connected via an elastic member.

10. The air-cleaner support structure according to claim 4, wherein
the center of vibration of the internal combustion engine is a center of roll vibration of the internal combustion engine.

11. The air-cleaner support structure according to claim 10, wherein
the second support portion is connected to the air-cleaner such that the second support portion moves in an arc about the center of roll vibration of the internal combustion engine.

12. The air-cleaner support structure according to claim 10, wherein
a U-shaped notch or an elongate hole is formed in the second support portion in which the insert member is inserted, so that the insert member moves in an arc about the center of roll vibration of the internal combustion engine while the second support portion is connected to the air-cleaner.
